(19) United States
(12) Patent Application Publication
(10) Pub. No.: US 2008/0253324 A1
(43) Pub. Date: Oct. 16, 2008

(54) Multiple Channel Communication

(75) Inventors: Timothy J. Moulsley, Caterham (GB); Bernard Hunt, Redhill (GB); David K. Roberts, Crawley (GB); Matthew P.J. Baker, Canterbury (GB); Filippo Tosato, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,984

(22) PCT Filed: Sep. 27, 2006
(86) PCT No.: PCT/IB2006/053512

§ 371 Date: Mar. 25, 2008

(30) Foreign Application Priority Data
Sep. 28, 2005 (EP) 05108979.5

(51) Int. Cl. H04Q 7/00

(52) U.S. Cl. 370/329

(57) ABSTRACT

A communication device (1) for communicating in a multiple channel communication system comprises means (9) for calculating an effective noise level of one of the channels of the system by applying an expectation operator to an estimated noise level affecting the channel based on time varying characteristics of the estimated noise level. The calculation of the effective noise level may also be based on an estimated path loss. The calculation of the effective noise level may also be based on an initial power level allocated to the respective channel. The effective noise level calculated for each channel may be employed in calculating power levels to be allocated to the respective channels.

### TECHNICAL FIELD

This invention relates to a communication device for operation in a multiple channel communication system and to a method of operating the same. A particular, but not exclusive, application of the invention is the calculation of an effective noise level for use in allocating power to the multiple communication channels of the system.

### BACKGROUND ART

Communication systems invariably have only limited bandwidth. Communication systems that use multiple channels share this bandwidth between the channels of the system and there are numerous schemes for deciding how the bandwidth should be shared. This invention concerns schemes that vary the power or such like with which signals are transmitted over different channels according to the quality of signals received over the different channels in order to optimise the overall performance of the system, e.g. by maximising say the overall communication capacity of the communication system.

For example, it is known that the capacity of a single communication channel between a transmitter and a receiver can be expressed as

C=B log₂(1+S/N) (1)

where C is channel capacity in bits per second, B is the bandwidth of the channel, S is the power with which a signal is received in the channel at a receiver and N is noise power in the channel at the receiver. Equation (1) can be re-formulated for two communication channels, with bandwidth B set at 1 for simplicity, as

Cₜₒₜₐₗ=log₂(1+P₁L₁/N₁)+log₂(1+(P₂)L₂/N₂) (2)

where Cₜₒₜₐₗ is the combined capacity of the two channels, P₁ is the transmitter power allocated to a first of the channels, P₂ is the transmitter power allocated to a second of the channels, L₁ is the path loss for the signal in the first channel, L₂ is the path loss for the signal in the second channel, N₁ is the noise power in the first channel at the receiver and N₂ is the noise power in the second channel at the receiver. If we assume that there is a restriction on the total transmission power Pₜₒₜₐₗ available at the transmitter and that this is equal to the combined powers P₁+P₂ allocated to the channels, and if all the other variables are known, it is fairly straightforward to derive powers P₁,P₂ for the first and second channels that maximise the combined capacity Cₜₒₜₐₗ of the two channels. This can be extended to any number i of channels by

$${C}_{total} = {\sum }_{i} {log}_{2} ( 1 + {P}_{i} {L}_{i} / {N}_{i} ) \qquad ( 3 )$$

where the aim is to maximise the total channel capacity Cₜₒₜₐₗ using the constraint that the total transmitter power Pₜₒₜₐₗ, or simply P, is the sum of the transmitter powers Pᵢ allocated to each of the channels, i.e.

$$P = {\sum }_{i} {P}_{i} .$$

However, such a scheme relies on the values of path loss Lᵢ and noise Nᵢ being known exactly. This is unlikely to be the case in a real communication system. For example, the values of path loss Lᵢ and noise Nᵢ generally rely on measurements made by receivers of the system, but the power allocation tends to be carried out at a transmitter. So, the receivers must usually report their measurements of path loss Lᵢ and noise Nᵢ to the transmitter before power allocation can take place. However, it is unlikely that the values of path loss Lᵢ and noise Nᵢ reported by the receivers relate to the same instant in time as one another. Furthermore, path loss Lᵢ and noise Nᵢ tend to vary rapidly with time. For example, noise Nᵢ can arise from various sources such as receiver noise and interference, which can vary rapidly with time. So, even if values of path loss Lᵢ and noise Nᵢ are known for all the i channels of the communication system at a given time, by the time the values are reported to the transmitter and power allocation performed, the values of path loss Lᵢ and noise Nᵢ on which the power allocation is based are out of date.

The present invention seeks to overcome these problems.

### DISCLOSURE OF INVENTION

According to a first aspect of the present invention, there is provided a communication device for operation in a multiple channel communication system, the device comprising means for calculating an effective noise level N_{eff,i} of one of the channels of the system by applying an expectation operator to an estimated noise level Nᵢ affecting the channel based on time varying characteristics of the estimated noise level Nᵢ.

Similarly, according to a second aspect of the present invention, there is provided a method of operating a communication device in a multiple channel communication system, the method comprising calculating an effective noise level N_{eff,i} of one of the channels of the system by applying an expectation operator to an estimated noise level Nᵢ affecting the channel based on time varying characteristics of the estimated noise level Nᵢ.

So, an effective noise level N_{eff,i} is calculated that takes into account the time varying characteristics of noise affecting the channel. The calculated effective noise level N_{eff,i} is therefore a far more reliable indication of the noise affecting the channel than a simple measure of noise at any given instant. Whilst use of an expectation operator can lead to fairly complex calculations, complexity can be minimised according to the invention by applying the expectation operator to the noise level Nᵢ of a single channel. Furthermore, the calculation of the effective noise level N_{eff,i} can be made at the receiving end of the channel, as it does not necessarily rely on knowledge of the other channels of the communication system.

Noise can arise from inherent features of the communication channel, such as components of a receiving circuit of the communication device for example. However, most time varying components of noise tend to result from interference. The applied expectation operator can take account of the probability of interference affecting the channel and the invention is therefore particularly effective at taking account of the presence of intermittent interference.

Another major factor that affects the ability of the communication device to receive a signal over the channel is path loss Lᵢ. Preferably, the calculation of the effective noise level N_{eff,i} is also therefore based on an estimated path loss Lᵢ over the channel. The calculated effective noise level N_{eff,i} then better represents the ability of the communication device to receive a signal over the channel

The expectation operator can be applied to the estimated noise level Nᵢ and or the estimated path loss Lᵢ to calculate the effective noise level N_{eff,i} of the channel in different ways. For example, the expectation operator might be applied just to the effective noise level N_{eff,i}. An example of such a calculation is given in equation (10) below. Alternatively, the expectation operator may be applied to both the estimated noise level Nᵢ and the estimated path loss Lᵢ. Examples of such calculations are given in equations (8) and (9) below. It can be appreciated that, in these examples, the expectation operator is applied to a ratio of the estimated noise level Nᵢ and the estimated path loss Lᵢ, although this is not strictly necessary.

In another example, the effective noise level calculation can also be based on another variable, such as an initial power \hat{P}ᵢ allocated to the channel. An example of such a calculation is given in equation (4) below. One difficulty with using an initial power \hat{P}ᵢ allocated to the channel in the calculation is that the communication device is not usually able to measure the initial power \hat{P}ᵢ allocated to the channel directly, as the power \hat{P}ᵢ may be set at another communication device with which the communication device communicates over the channel. When the effective noise level calculation is based the initial power \hat{P}ᵢ allocated to the channel, the communication device may therefore have means for receiving an indication of the initial power \hat{P}ᵢ allocated to the channel from another communication device with which the communication device communicates over the channel. Similarly, the method may comprise receiving an indication of the initial power \hat{P}ᵢ allocated to the channel from another communication device with which the operated communication device communicates over the channel. The indication of the initial power \hat{P}ᵢ can then be used as the initial power \hat{P}ᵢ allocated to the channel in the calculation of the effective noise level N_{eff,i}. So, even if the other communication device performs power allocation, the actual power that has been allocated to the channel can be used as the initial power \hat{P}ᵢ allocated to the channel in the calculation.

However, this is not always appropriate. For example, there may be no available mechanism for transmitting an indication of the initial power \hat{P}ᵢ allocated to the channel over the channel. So, the communication device of the invention may comprise means for estimating the initial power \hat{P}ᵢ allocated to the channel. Likewise, the method may comprise estimating an initial power \hat{P}ᵢ allocated to the channel. In one example, this is achieved by dividing a total expected available power by an expected total number of channels. The total expected available power and total number of channels may be known exactly. However, in other examples, they may be estimated, e.g. from other properties of the channel. In a particularly preferred example of the invention, the initial power \hat{P}ᵢ allocated to the channel may be estimated from power previously allocated to the channel.

Typically, the main purpose of calculating the effective noise level N_{eff,i} is to facilitate allocation of actual power to the multiple channels of the communication system. This power allocation typically needs to be carried out with knowledge of the effective noise level N_{eff,i} in more than one channel of the communication system. So, in one example, the effective noise level calculation means of the communication device may calculate respective effective noise levels N_{eff,i} for the multiple channels of the system. Similarly, the method may comprise calculating respective effective noise levels N_{eff,i} for the multiple channels of the system. This can be useful when the communication system comprises multiple communication channels between the communication device and an/the other communication device, e.g. a Multiple Input Multiple Output (MIMO) communication system. It can also be useful when one communication device communicates with more than one other communication device via respective different channels of the communication system. For example, the communication device might receive the estimated noise level Nᵢ and/or estimated path loss Lᵢ from the other communication devices. It can then calculate the respective effective noise levels N_{eff,i} for the channels over which it communicates with those other devices based on the received estimated noise levels Nᵢ and/or estimated path losses Lᵢ.

However, in other examples, the power allocation can be carried out at an/the other communication device with which the communication device of the invention communicates over the channel. So, the communication device of the invention might comprise means for transmitting the calculated effective noise level N_{eff,i} of the channel to an/the other communication device with which the communication device communicates over the channel. Similarly, the method may comprise transmitting the calculated effective noise level N_{eff,i} of the channel to an/the other communication device with which the operated communication device communicates over the channel. Here, the estimated noise level Nᵢ and/or estimated path loss Lᵢ on which the effective noise level N_{eff,i} calculation is based might be estimated by respective noise level estimation means and/or path loss estimation means, e.g. incorporated in the communication device; or estimation of the estimated noise level Nᵢ and/or estimated path loss Lᵢ might be incorporated in the method of the invention. In this example, the other communication device can receive the calculated effective noise level N_{eff,i} of the channel from the communication device of the invention (along with other calculated effective noise levels N_{eff,i} from other such devices) and perform the power allocation as desired.

It can be appreciated that the power allocation typically comprises calculating powers Pᵢ to be allocated to the multiple channels based on the calculated effective noise levels N_{eff,i} of the multiple channels. This is considered new in itself and, according to a third aspect of the present invention, there is provided a communication device for communicating in a multiple channel communication system, the communication device comprising:

means for receiving effective noise levels N_{eff,i} of the multiple channels, which effective noise levels N_{eff,i} are calculated by applying an expectation operator to an estimated noise level Nᵢ affecting a respective channel based on time varying characteristics of the estimated noise level Nᵢ; and

means for calculating powers Pᵢ to be allocated to the respective channels of the system by maximising total capacity Cₜₒₜₐₗ of the channels based on the received effective noise levels N_{eff,i} of the channels.

Also, according to a fourth aspect of the present invention, there is provided a method of operating a communication device in a multiple channel communication system, the method comprising:

receiving effective noise levels N_{eff,i} of the multiple channels, which effective noise levels N_{eff,i} are calculated by applying an expectation operator to an estimated noise level Nᵢ affecting a respective channel based on time varying characteristics of the estimated noise level Nᵢ; and

calculating powers Pᵢ to be allocated to the respective channels of the system based on the received effective noise levels N_{eff,i} of the channels.

The power allocation comprises maximising total capacity Cₜₒₜₐₗ of the multiple channels based on the received effective noise levels N_{eff,i} of the channels. This can be achieved in a variety of ways, including the well known “water filling” arrangement or such like. (A description of “water filling” may be found in “On constant power water-filling”, Wei Yu, Cioffi, J. M., IEEE International Conference on Communications, Volume 6, 11-14 Jun. 2001, pages 1665-1669). However, a particularly preferred relation for calculating powers Pᵢ to be allocated to the multiple channels is given in equation (7) below. In another example, the calculation of the powers Pᵢ to be allocated to the multiple channels can be achieved by distributing a total transmission power equally amongst a number of the multiple channels having lower calculated effective noise levels N_{eff,i}. In other words, the channels may be listed in order of increasing effective noise level N_{eff,i} and the total power divided equally among a number of channels first in the list. The number might fixed, or it might be selected to maximise total capacity Cₜₒₜₐₗ of the multiple channels.

### BRIEF DESCRIPTION OF DRAWINGS

Preferred embodiments of the invention will now be described, by way of example only, with reference to the accompanying drawings, in which:

FIG. 1 is a schematic illustration of a communication system according to a first preferred embodiment of the invention;

FIG. 2 is a schematic illustration of a method of allocating power to downlinks of the communication system illustrated in FIG. 1;

FIG. 3 is a graphical illustration of a fraction of transmission power allocated to one of the downlinks of the communication system illustrated in FIG. 1 versus the probability of interference in the downlink for power allocation methods according to different preferred embodiments of the invention; and

FIG. 4 is a graphical illustration of overall communication capacity of the communication system illustrated in FIG. 1 versus the probability of interference in one of the downlinks for power allocation methods according to different preferred embodiments of the invention.

### MODES FOR CARRYING OUT THE INVENTION

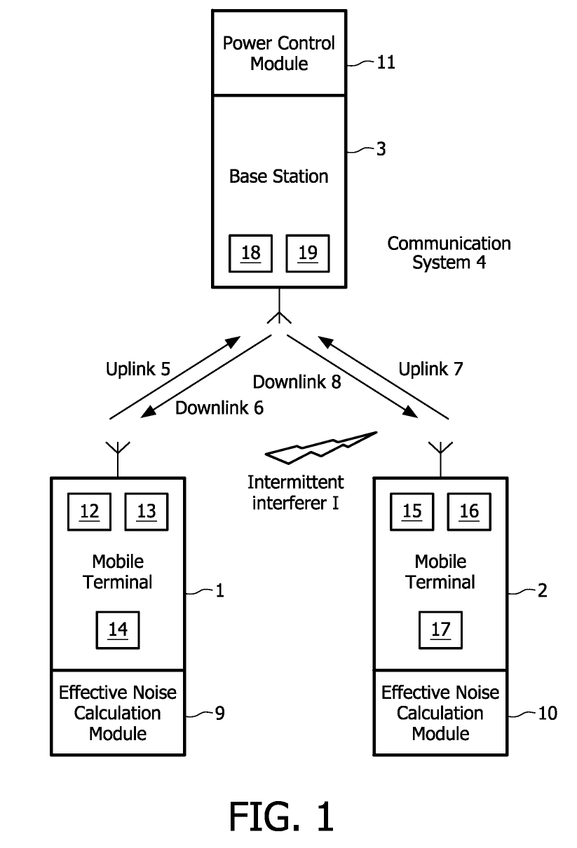

Referring to FIG. 1, two mobile terminals 1, 2 are able to communicate with a base station 3 of a communication system 4. A first of the mobile terminals 1 has a transmitter 12 for transmitting signals to the base station 3 over a first uplink 5, a receiver 13 for receiving signals from the base station 3 over a first downlink 6, and may have a processor 14 for calculating power such as estimating an initial power level or calculating powers to be allocated to communication channels. Similarly, a second of the mobile terminals 2 has a transmitter 15 for transmitting signals to the base station 3 over a second uplink 7, a receiver 16 for receiving signals from the base station 3 over a second downlink 8, and may have a processor 17 for calculating power levels such as estimating an initial power level or calculating powers to be allocated to communication channels. The mobile terminals 1, 2 each have an effective noise calculation module 9, 10 for calculating effective noise N_{eff,1} in the first downlink 6 and effective noise N_{eff,2} in the second downlink 8 respectively.

The base station 3 has a transmitter 18 for transmitting signals to the mobile terminals 1, 2, a receiver 19 for receiving signals from the mobile terminals 1,2, and a power control module 11 for controlling an amount of power allocated to the two downlinks 6, 8.

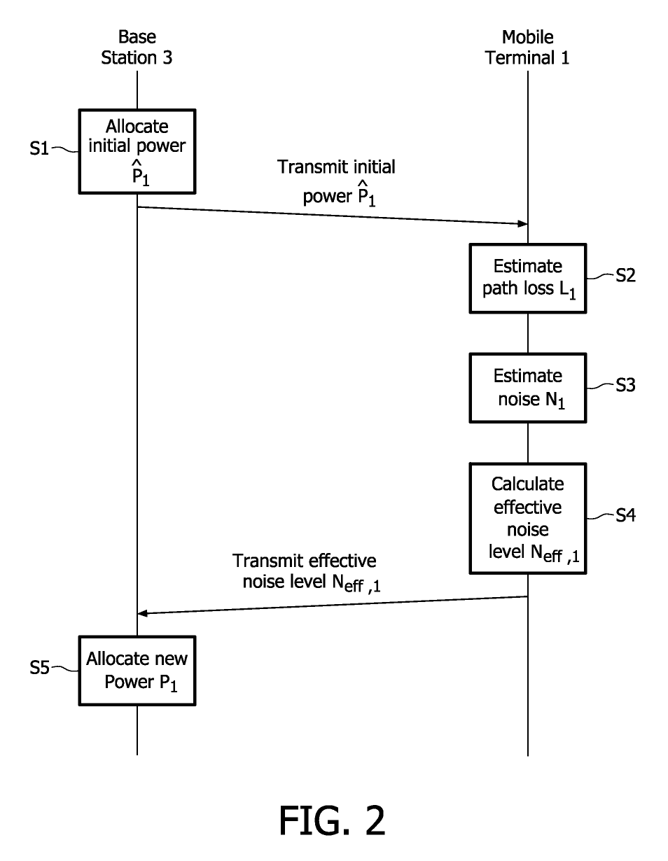

Referring to FIG. 2, in operation, the power control module 11 of the base station 3 allocates a first initial power \hat{P}₁ to the first downlink 6 and second initial power \hat{P}₂ to the second downlink 8 at step S1. These initial powers \hat{P}₁, \hat{P}₂ are used for transmitting signals to the mobile terminals 1, 2 over the downlinks 6, 8. Indications of the values of the initial powers \hat{P}₁, \hat{P}₂ are also transmitted to the mobile terminals 1, 2 over the downlinks 6, 8.

At step S2, the effective noise calculation modules 9, 10 of each of the mobile terminals 1, 2 estimate the path loss Lᵢ in the first downlink 6 and the path loss L₂ in the second downlink 8 respectively. At step S3, the effective noise calculation modules 9, 10 of each of the mobile terminals 1, 2 estimate a noise level N₁ in the first downlink 6 and a noise level N₂ in the second downlink 8 respectively. The estimated noise levels N₁,N₂ include contributions from both noise and interference in the downlinks 6, 8. Indeed, the effective noise calculation modules 9, 10 actually estimate multiple noise levels N₁,N₂; . . . ; N₁ₜ₋₁ N_{2,t-1}; N_{1,t},N_{2,t} at different times to monitor how the noise levels N₁,N₂ vary with time t. These multiple noise levels N₁,N₂; . . . ; N_{1,t-1} N_{2,t-1}; N_{1,t},N_{2,t} are used to generate average noise levels N₁,N₂ to be used as the estimated noise levels N₁,N₂ of the downlinks 6, 8. Furthermore, where the multiple noise levels N₁,N₂; . . . ; N_{1,t-1} N_{2,t-1}; N_{1,t},N_{2,t} for either of the channels vary significantly over time t, more than one noise level is estimated, along with a probability p of each noise level being present.

At step S4, the effective noise calculation modules 9, 10 of each of the mobile terminals 1, 2 calculates the effective noise N_{eff,1} in the first downlink 6 and the effective noise N_{eff,2} in the second downlink 8 respectively from the respective initial powers \hat{P}₁, \hat{P}₂ allocated to the downlinks 6, 8, estimated path losses L₁, L₂, and estimated noise levels N₁,N₂, using the relation

$${N}_{eff , i} = \frac{{\hat{P}}_{i}}{{2}^{〈 {log}_{2} ( 1 + {\hat{P}}_{i} {L}_{i} / {N}_{i} ) 〉} - 1} \qquad ( 4 )$$

where i is the number of the mobile terminal 1, 2 and [symbol] [symbol] is an expectation operator.

By way of illustration, the power control module 11 of the base station 3 may initially divide the total transmission power P of the base station 3 equally between the two downlinks 6, 8. In other words, both the first initial power \hat{P}₁ and the second initial power \hat{P}₂ may be equal to half of the total transmission power P, i.e. \hat{P}₁=\hat{P}₂=0.5 P.

The first downlink 6 of the mobile terminal 1 may have a noise level N₁ that does not vary significantly with time t. So, the effective noise calculation module 9 simply takes an average of the multiple noise levels N₁; . . . ; N_{1,t-1}; N_{1,t} estimated for the first downlink 6 to give a single estimated noise level N₁ for the first downlink 6. The effective noise N_{eff,1} in the first downlink 6 may then be calculated as

$${N}_{eff , 1} = \frac{0.5 P}{{2}^{{log}_{2} ( 1 + 0.5 {PL}_{1} / {N}_{1} )} - 1} \qquad ( 5 )$$

In contrast, the noise level N₂ of the second downlink 8 has an intermittent interferer, illustrated as arrow I in FIG. 1. The estimated noise levels N₂; . . . ; N_{2,t-1}; N_{2,t} for the second downlink 8 may therefore have a first average level N_{2,A} when the interferer in absent and a second average level N_{2,B} when the interferer is present. The interferer has a probability p₂ of being present in the downlink 8. So, the effective noise N_{eff,2} in the second downlink 8 may be calculated as

$${N}_{eff , 2} = \frac{0.5 P}{{2}^{( 1 - {p}_{2} ) {log}_{2} ( 1 + 0.5 {PL}_{2} / {N}_{2 , A} ) + {p}_{2} {log}_{2} ( 1 + 0.5 {PL}_{2} / {N}_{2 , B} )} - 1} \qquad ( 6 )$$

Once these effective noise levels N_{eff,1}N_{eff,2} have been calculated by the effective noise calculation modules 9, 10, the mobile terminals 1, 2 transmit them to the base station 3 over the uplinks 5, 7. The base station 3 receives the calculated effective noise levels N_{eff,1}N_{eff,2} for each of the downlinks 6, 8 and, at step S5, the power control module 11 of the base station 3 allocates new powers P₁,P₂ to the first downlink 6 and second downlink 8 based on the received effective noise levels N_{eff,1}N_{eff,2}. More specifically, the power control module 11 optimises the relation

$${C}_{total} = {\sum }_{i} {log}_{2} ( 1 + {P}_{i} / {N}_{eff , i} ) \qquad ( 7 )$$

to maximise the combined capacity Cₜₒₜₐₗ of the two downlinks 6, 8, with the constraint on total power P being

$$P = {\sum }_{i} {P}_{i} .$$

The new powers P₁,P₂ can then be used as the initial powers \hat{P}₁,\hat{P}₂ and steps S2 to S5 can be repeated to adjust the power allocation as often as desired.

In another embodiment of the invention, the effective noise calculation modules 9, 10 of each of the mobile terminals 1, 2 calculates the effective noise N_{eff,1},N_{eff,2} in the first and second downlinks 6, 8 using the relation

$${N}_{eff , i} = \frac{1}{〈 {L}_{i} / {N}_{i} 〉} \qquad ( 8 )$$

This simplifies the signalling in the communication system, as no knowledge is required of the power allocated to the downlinks 6, 8 by the mobile terminals 1, 2. It can also simplify the calculation of the effective noise N_{eff,1},N_{eff,2} in the downlinks 6, 8, as the relation is simpler. However, this relation is only likely to be accurate for low noise levels N₁,N₂. Certain assumptions also need to be made about the magnitude of the path losses L₁,L₂, such as using relative rather than absolute magnitudes.

In another embodiment of the invention, the effective noise calculation modules 9, 10 of each of the mobile terminals 1, 2 calculates the effective noise N_{eff,1},N_{eff,2} in the first and second downlinks 6, 8 using the relation

N_{eff,i}= [symbol] Nᵢ/Lᵢ [symbol] (9)

This relation is very similar to relation given in equation (8) above, but slightly simpler to calculate. In yet another embodiment, the effective noise calculation modules 9, 10 of each of the mobile terminals 1, 2 calculates the effective noise N_{eff,1},N_{eff,2} in the first and second downlinks 6, 8 using the relation

N_{eff,i}= [symbol] Nᵢ [symbol] /Lᵢ (10)

This is useful when the path losses L₁,L₂ are certain or do not vary significantly, such as in a wired communication system, for example, where the uplinks 5, 7 and downlinks 6, 8 are transmitted over wires.

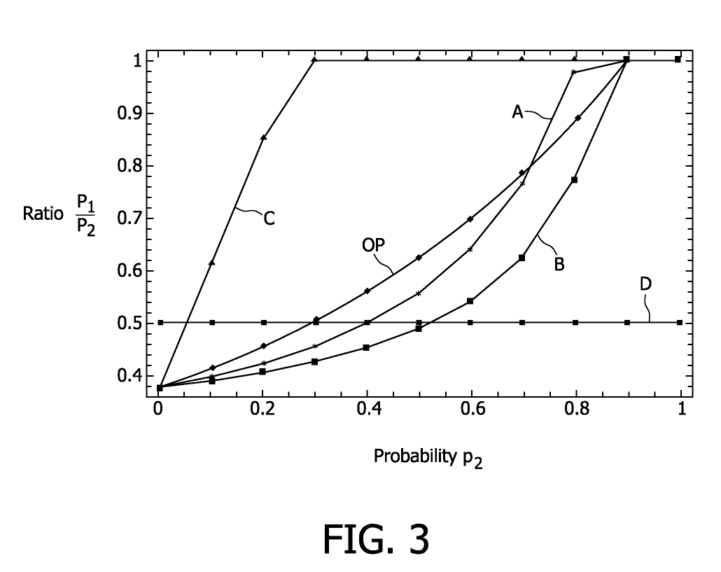

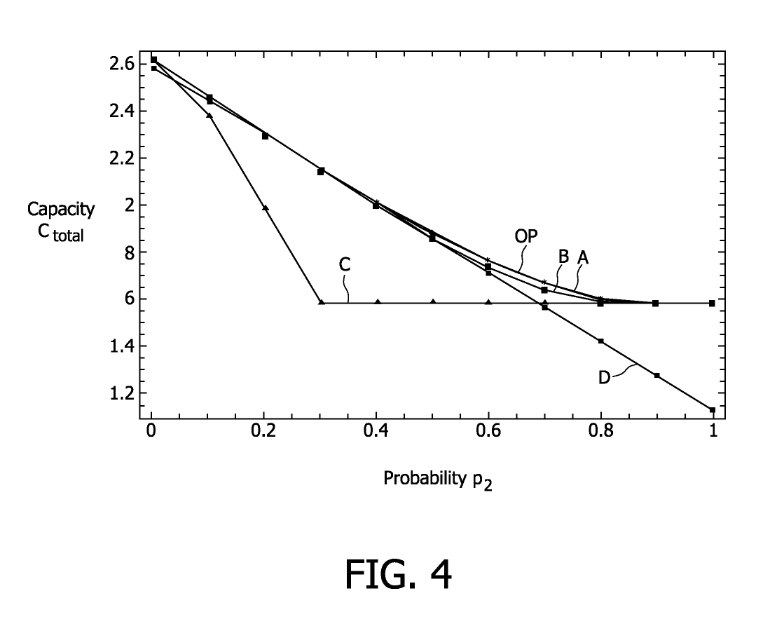

Differences in the reliability and accuracy of these relations is illustrated in FIGS. 3 and 4. Here, we assume that the path losses L₁,L₂ are both equal to unity; the initial powers \hat{P}₁, \hat{P}₂ allocated to the downlinks 6, 8 are both equal to unity; the total power P is 2; the noise level N₁ in the first downlink 6 is unity; the first average level N_{2,A} when the interferer in absent in the second downlink 8 is 0.5; and the second average level N_{2,B} when the interferer is present in the second 8 is 10.

Ratios between the actual powers P₁,P₂ allocated to the downlinks 6, 8 by the relation given in equation (7) using each of the relations given in equations (4), (8) and (9) to calculate effective noise N_{eff,i} are plotted in the graph shown in FIG. 3 for different probabilities p₂ of the interferer being present in the second downlink 8. The optimum power allocation is shown by line OP. It can be seen that the lines A and B, which represent use of the relations given by equations (4) and (8) respectively to calculate effective noise N_{eff,i} conform closely to the optimum power allocation. Line C, which represents use of the relation given by equations (9) to calculate effective noise N_{eff,i}, conforms less well to the optimum power allocation, but is still useful. Line D illustrates equal power allocation for reference.

Similarly, the combined capacity Cₜₒₜₐₗ of the downlinks 6, 8 calculated using the relation given in equation (7), using each of the relations given in equations (4), (8) and (9) to calculate effective noise N_{eff,i}, is plotted in the graph shown in FIG. 4 for different probabilities p₂ of the interferer being present in the second downlink 8. The optimum combined capacity Cₜₒₜₐₗ of the downlinks 6, 8 is shown by line OP. It can be seen that, again, lines A and B, which represent use of the relations given by equations (4) and (8) respectively to calculate effective noise N_{eff,i}, conform closely to the optimum combined capacity Cₜₒₜₐₗ of the downlinks 6, 8. Likewise, line C, which represents use of the relation given by equations (9) to calculate effective noise N_{eff,i}, conforms less well to the optimum combined capacity Cₜₒₜₐₗ of the downlinks 6, 8, but is still useful. Line D illustrates combined capacity Cₜₒₜₐₗ of the downlinks 6, 8 with equal power allocation for reference.

The embodiments of the invention described above can be modified in a variety of ways. For example, rather than using initial powers \hat{P}₁, \hat{P}₂ that are equal to one another, a “water filling” algorithm could be used for the initial power allocation. Indeed, a “water filling” algorithm based on the effective noise levels N_{eff,i} calculated by the effective noise calculation modules 9, 10 could be used by the power control module 11 of the base station 3 to allocate power to the downlinks 6, 8 instead of the relation given in equation (4). Similarly, when there are several downlinks, the power control module 11 can calculate the powers Pi allocated to the downlinks by distributing the total power P equally amongst a number of the downlinks having lower calculated effective noise levels N_{eff,i}. For example, the power control module 11 may maintain a list of downlinks arranged in order of increasing effective noise level N_{eff,i} and divide the total power P equally among a number of downlinks first in the list. The number might be fixed, or it might be selected to maximise total capacity Cₜₒₜₐₗ of the multiple downlinks.

In another variation, instead of analysing the estimated noise levels N₁,N₂; . . . ; N_{1,t-1} N_{2,t-1}; N_{1,t},N_{2,t} to derive the probability p of an interferer being present (or the noise in a downlink 6, 8 otherwise changing) other properties of the downlink may be considered. For example, a number of re-transmitted packets may be monitored. More specifically, requests in a communication system 4 using an automatic repeat request (ARQ) protocol may be monitored. Similarly, path loss L could be derived from information about both the downlinks 6, 8 and uplinks 5, 7 in a Time Division Duplex (TDD) communication system or such like.

The embodiments of the invention are described above in relation to a single multiple channel communication system 4 having two mobile terminals 1, 2. However, these terminals 1, 2 need not necessarily be mobile and there may be any number of such terminals 1, 2 in the communication system 4. These terminals 1, 2 may communicate using the same protocols and frequencies or completely different protocols and frequencies. For example, they may communicate using Universal Mobile Telecommunications System (UMTS) and/or Global System for Mobile Communications (GSM) technology. The invention is also applicable to Multiple Input Multiple Output (MIMO) systems, in which there can be multiple uplinks 5, 7 and downlinks 6, 8 between just two individual terminals.

Although the use of the calculated effective noise level N_{eff,i} has been described in relation to allocating the transmit power to multiple channels of a communication system, the effective noise level can alternatively or additionally be use in selecting other transmission parameters for each of the channels, such as bits rates, modulations schemes and coding.

Although equations (3), (4), (8), (9) and (10) have been expressed with an equal sign, further factors may be included so in general these equations may be expressed using an proportional sign in place of the equal sign.

Indeed, the described embodiments of the invention are only examples of how the invention may be implemented. Other modifications, variations and changes to the described embodiments will occur to those having appropriate skills and knowledge. These modifications, variations and changes may be made without departure from the spirit and scope of the invention defined in the claims and its equivalents.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

### INDUSTRIAL APPLICABILITY

Multi-channel communication systems.

1. A communication device for communicating in a multiple channel communication system, the device comprising means for calculating an effective noise level of one of the channels of the system by applying an expectation operator to an estimated noise level affecting the channel based on time varying characteristics of the estimated noise level.

2. The communication device of claim 1, wherein the effective noise level calculation means bases the calculation of the effective noise level on an estimated path loss over the channel.

3. The communication device of claim 1, wherein the effective noise level calculation means bases the calculation of the effective noise level on the relation
N_{eff,i}∝ [symbol] Nᵢ [symbol] /Lᵢ
where [symbol] [symbol] is the expectation operator and Lᵢ is an estimated path loss over the channel.

4. (canceled)

5. (canceled)

6. The communication device of claim 1, wherein the effective noise level calculation means bases the calculation of the effective noise level on the relation
$${N}_{eff , i} ∝ \frac{1}{〈 {L}_{i} / {N}_{i} 〉}$$
where [symbol] [symbol] is the expectation operator and Lᵢ is an estimated path loss over the channel.

7. The communication device of claim 1, wherein the effective noise level calculation means bases the calculation of the effective noise level on an initial power allocated to the channel.

8. The communication device of claim 7, wherein the effective noise level calculation means bases the calculation of the effective noise level on the relation
$${N}_{eff , i} ∝ \frac{{\hat{P}}_{i}}{{2}^{〈 {log}_{2} ( 1 + {\hat{P}}_{i} {L}_{i} / {N}_{i} ) 〉} - 1}$$
where [symbol] [symbol] is the expectation operator and Lᵢ is an estimated path loss over the channel.

9. The communication device of claim 7, comprising means for receiving an indication of the initial power allocated to the channel from another communication device with which the communication device communicates over the channel.

10. The communication device of claim 7, comprising means for estimating the initial power allocated to the channel.

11. The communication device of claim 10, wherein the initial power estimation means estimates the initial power allocated to the channel by dividing a total expected transmission power of another communication device with which the communication device communicates over the channel by an expected total number of channels.

12. The communication device of claim 10, wherein the initial power estimation means estimates the initial power allocated to the channel to be power previously allocated to the channel.

13. The communication device of claim 1, comprising means for transmitting the calculated effective noise level of the channel to another communication device with which the communication device communicates over the channel.

14. The communication device of claim 1, wherein the effective noise level calculation means calculates respective effective noise levels for the multiple channels of the system.

15. The communication device of claim 14, comprising means for calculating powers to be allocated to the channels of the system based on the calculated effective noise levels of the channels.

16. A communication device for communicating in a multiple channel communication system, the communication device comprising:
means for receiving effective noise levels of the multiple channels, which are calculated by applying an expectation operator to an estimated noise level affecting a respective channel based on time varying characteristics of the estimated noise level; and
means for calculating powers to be allocated to the multiple channels of the system based on the received effective noise levels of the channels.

17. The communication device of claim 15, wherein the means for calculating the powers to be allocated to the respective channels bases calculates the powers by maximising total capacity of the channels.

18. The communication device of claim 17, wherein the means for calculating the powers to be allocated to the respective channels bases the calculation of the powers on the relation
$${C}_{total} ∝ {\sum }_{i} {log}_{2} ( 1 + {P}_{i} / {N}_{eff , i} )$$

19. The communication device of claim 15, wherein the means for calculating the powers to be allocated to the respective channels distributes a total transmission power equally amongst a number of the channels having lower calculated effective noise levels.

20. The communication device of claim 18, wherein the means for calculating the powers to be allocated to the multiple channels selects the number of the multiple channels amongst which the total transmission power is distributed to maximise total capacity of the multiple channels.

21. A method of transmitting data in a multiple channel communication system, the method comprising calculating an effective noise level of one of the channels of the system by applying an expectation operator to an estimated noise level affecting the channel based on time varying characteristics of the estimated noise level.

22. The method of claim 21, wherein the calculation of the effective noise level is based on an estimated path loss over the channel.

23. The method of claim 21, wherein the calculation of the effective noise level is based on the relation
N_{eff,i}∝ [symbol] Nᵢ [symbol] /Lᵢ
where [symbol] [symbol] is the expectation operator and Lᵢ is an estimated path loss over the channel.

24. The method of claim 21, wherein the expectation operator is applied to an estimated path loss over the channel based on time varying characteristics of the estimated path loss.

25. (canceled)

26. The method of claim 21, wherein the calculation of the effective noise level is based on the relation
$${N}_{eff , i} ∝ \frac{1}{〈 {L}_{i} / {N}_{i} 〉}$$
where [symbol] [symbol] is the expectation operator and Lᵢ is an estimated path loss over the channel.

27. The method of claim 21, wherein the calculation of the effective noise level is based on an initial power allocated to the channel.

28. (canceled)

29. The method of claim 27, comprising receiving an indication of the initial power allocated to the channel from another communication device with which the operated communication device communicates over the channel.

30. The method of claim 27, comprising estimating the initial power allocated to the channel.

31. The method of claim 30, comprising estimating the initial power allocated to the channel by dividing a total expected transmission power of another communication device with which the operated communication device communicates over the channel by an expected total number of channels.

32. The method of claim 30, comprising estimating the initial power allocated to the channel to be power previously allocated to the channel.

33. The method of claim 21 comprising transmitting the calculated effective noise level of the channel to an/the other communication device with which the operated communication device communicates over the channel.

34. The method of claim 1, comprising calculating respective effective noise levels for the multiple channels of the system.

35. The method of claim 34, comprising calculating powers to be allocated to the channels of the system based on the calculated effective noise levels of the channels.

36. A method of transmitting data in a multiple channel communication system, the method comprising:
receiving effective noise levels of the multiple channels, which are calculated by applying an expectation operator to an estimated noise level affecting a respective channel based on time varying characteristics of the estimated noise level; and
calculating powers to be allocated to the multiple channels of the system based on the received effective noise levels of the channels.

37. The method of claim 35, further comprising calculating the powers to be allocated to the multiple channels of the system by maximising total capacity of the channels.

38. The method of claim 37, further comprising calculating the powers to be allocated to the respective channels based on the relation
$${C}_{total} ∝ {\sum }_{i} {log}_{2} ( 1 + {P}_{i} / {N}_{eff , i} )$$

39. The method of claim 35, further comprising calculating the powers be allocated to the respective channels by distributing a total transmission power equally amongst a number of the channels having lower calculated effective noise levels.

40. The method of claim 39, further comprising calculating the powers to be allocated to the multiple channels by selecting the number of the multiple channels amongst which the total transmission power is distributed to maximise total capacity of the multiple channels.
